(19) United States
(12) Patent Application Publication
(10) Pub. No.: US 2018/0095794 A1
(43) Pub. Date: Apr. 5, 2018

(54) Efficient Load-Balancing Method and System for Tree-Based Applications

(71) Applicant: Egypt Japan University of Science and Technology, Alexandria (EG)

(72) Inventors: Ahmed Hazem Mohamed Rashid Elmahdy, Alexandria (EG); Osama Talaat Abdel-Hafiz Ibrahim, Sharkia (EG)

(21) Appl. No.: 15/285,564

(22) Filed: Oct. 5, 2016

(51) Int. Cl. G06F 9/50

(52) U.S. Cl. CPC G06F 9/505

(57) ABSTRACT

In a system having multiple parallel processors, a process to enhance performance of tree based applications by balancing the processing load amongst all available parallel processors when processing the tree structure. Tree nodes and leaves are uniformly sampled at random to estimate the corresponding work (such as node counts and leave work). This is done through novel uniform node sample and weighted random depth probing. A linear workload mapping then maps subtrees into sub-intervals of a one-dimensional interval. Such mapping facilities inverse mapping of the estimated workload to achieve efficient partitioning of the tree. The process further adaptively decides upon subtrees to sample allowing for matching with the characteristics of input trees, decreasing the number of probes, while resulting in accurate load-balancing. The process provides for fast load balancing for complex tree-based applications by exploiting statistical random sampling and requires only modest memory resources for such process making it suitable and applicable to even modest embedded devices. A significant speedup in processing is achieved which increases with the number of available processors.

### FIELD OF THE INVENTION

The present invention relates generally to a system and method for load balancing. In particular, it relates to load balancing method and system for tree-based applications.

### BACKGROUND OF THE INVENTION

In multiprocessor systems, load balancing is an essential process, which consists essentially of re-assigning the total workload to the individual processors of the system, preferably resulting in faster processing times and efficient utilization of resources.

Trees are important nonlinear structures that arise in computer algorithms and applications. An unbalanced tree has a random number of leaves per node. Applications that are based on exploration of unbalanced trees require continuous dynamic load balancing. Applications that fit in this category include many search and optimization problems. The divide-and-conquer paradigm is based on a tree structure in the running sequence. The divide-and-conquer application is found in many fields with huge importance, such as sorting (quick sort and merge sort) and the Fast Fourier transform. Another important application is game trees that are used to provide artificial intelligence in playing games such as Chess and Go.

The problem facing many tree-based algorithms is that the produced tree is usually unbalanced with respect to the data distribution. Therefore, tasks distribution over a group of processors or computers in a parallel processing model is not a straightforward process.

The load-balancing problem has been addressed previously but not in the manner proposed herein. Several load balancing algorithms are available, for example Round Robin and Randomized Algorithms, Central Manager Algorithm and Threshold Algorithm. However, those algorithms depend on static load balancing, which assumes that the workload is initially known before running the algorithm.

Dynamic algorithms, such as the Central Queue algorithm and the Local Queue algorithm, introduce runtime overhead, as they provide general tasking distribution mechanisms that do not exploiting tree aspects.

Researchers have suggested a dynamic load balancing method for trees, however, the method is concerned mainly with the multidimensional binary search tree for k-means, which does not target general trees.

Another related work is U.S. Pat. No. 8,056,086. The method disclosed therein is the closet to our method in terms of the adopted hybrid static and dynamic approach, however, the method targets the statically structured objects of images, and does not consider irregular data structures, such as trees.

Another related work is Knuth tree cost estimator. However, the method traverses the tree randomly terminating at a node with no children and thus does not provide for uniform sampling for nodes at the same depth, resulting in an estimator bias. Moreover, the method requires substantial number of computations. On a more general level, the method also does not provide for load-balancing.

Thus none of the methods in the prior art consider the specific problem of tree load balancing, and related approaches merely provide for general dynamic task distribution, which introduces considerable runtime overheads.

### SUMMARY OF THE INVENTION

The novelty of this invention lies into main two parts. The first part is in using random tree traversal to estimate the corresponding work in the tree. The random traversal provides for both estimating the work related to the node count in any general tree, as well as related to the leaves of the tree for full trees. The former is done through a novel traversal probing that uniformally samples the nodes in each level of the tree and a novel weighted random leaves probing that results in uniform sampling of the leaves.

The second part devises a linear workload mapping that maps subtrees into sub-intervals of a one-dimensional interval. Such mapping facilitates inverse mapping of the estimated workload to achieve efficient partitioning of the tree. The invention further adaptively decides upon subtrees to sample allowing for matching with the characteristics of input trees, decreasing the number of probes, while resulting in accurate load-balancing.

The input to the method is a tree; the input may be the actual tree or a data structure or a routine that would generate the tree.

The first stage of the method, ‘Tree Trivial Partitioning’ partitions the tree by a simple traversal to top nodes, resulting in a fixed number of subtrees equal to the number of available processors in the system.

Each of these subtrees is fed to the ‘Work Estimator’ process, where the work of the corresponding subtree is estimated. The process relies on both uniform sampling the nodes inside each tree level as well as the leaves. The obtained work for the subtrees are mapped into corresponding one-dimensional sub-intervals in the ‘Cummulative Work Distribution Generator’ process, effectively generating a work distribution function. The work distribution is then fed to the ‘Linearized-Load Reverse Mapper’ process generating the corresponding tree work intervals; however, the process iteratively checks the accuracy of each interval by computing the distance of the interval bounds to the closest work distribution point. If the distance is high, the processes invokes the ‘Adaptive Work Estimator’ process to estimate the work of a subtree, at the mid point of the corresponding two successive work distribution points. That process in turns invokes the ‘Tree Work Estimator’, adds the corresponding points to the work distribution, and forward it back to the Linarized-Load Reverse Mapper′ process.

The final process, ‘Tree partitioner’, maps the obtained intervals into a set of subtrees where each set represents the load-balanced workload of a processor. For the sake of simplicity, a binary tree is used herein as an example to explain the invention, but one of skill in the art would realize that the technique could apply to trees with nodes having any number of children.

The method provides for fast load balancing for complex tree-based applications by exploiting statistical random sampling, and requires modest memory resources for such processing, making it suitable and applicable to even modest embedded devices. Further, the method achieves significant speedup which increased with the number of processors.

### BRIEF DESCRIPTION OF THE DRAWINGS

FIG. 1 provides an overview of the system of the present invention.

FIG. 2 shows an example of a binary tree.

FIG. 3 is a flow chart of the Tree Trivial Partitioner process shown in FIG. 1.

FIG. 4 is an example of the binary tree of FIG. 2 after the Tree Trivial Partitioner process of FIG. 3.

FIG. 5 is a flow chart showing the Work Estimator process shown in FIG. 1.

FIG. 6 is a flow chart showing the computation of depth by random probing.

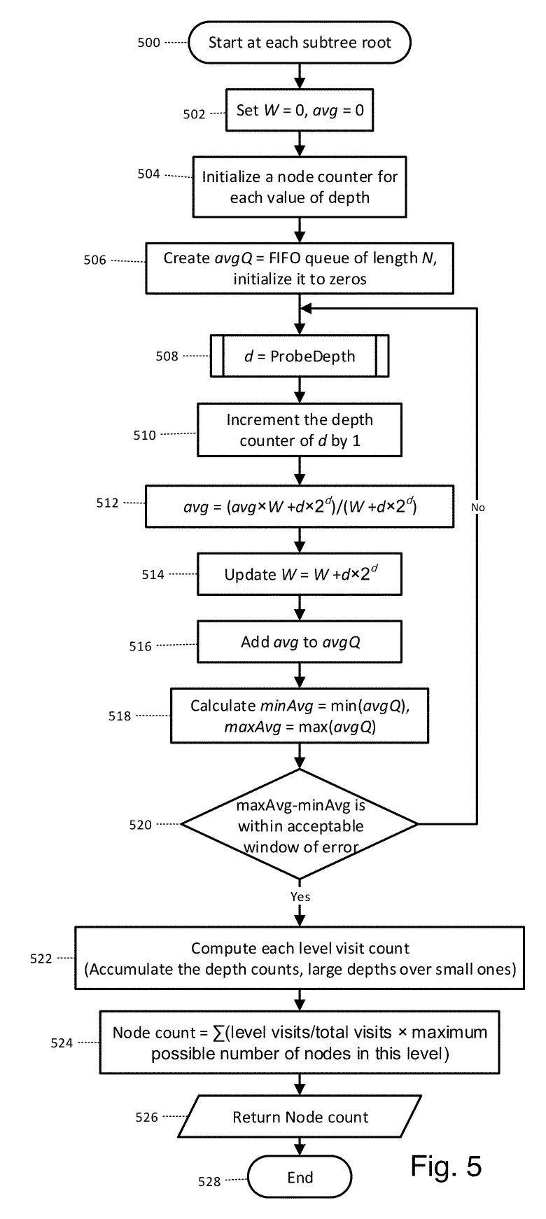

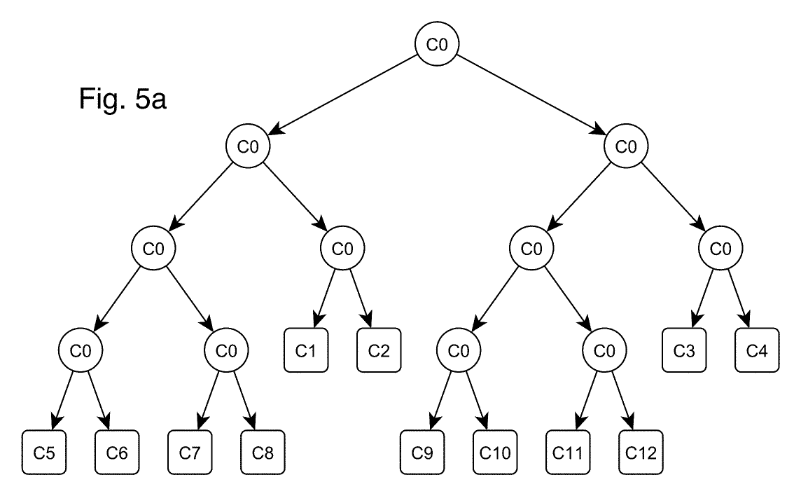

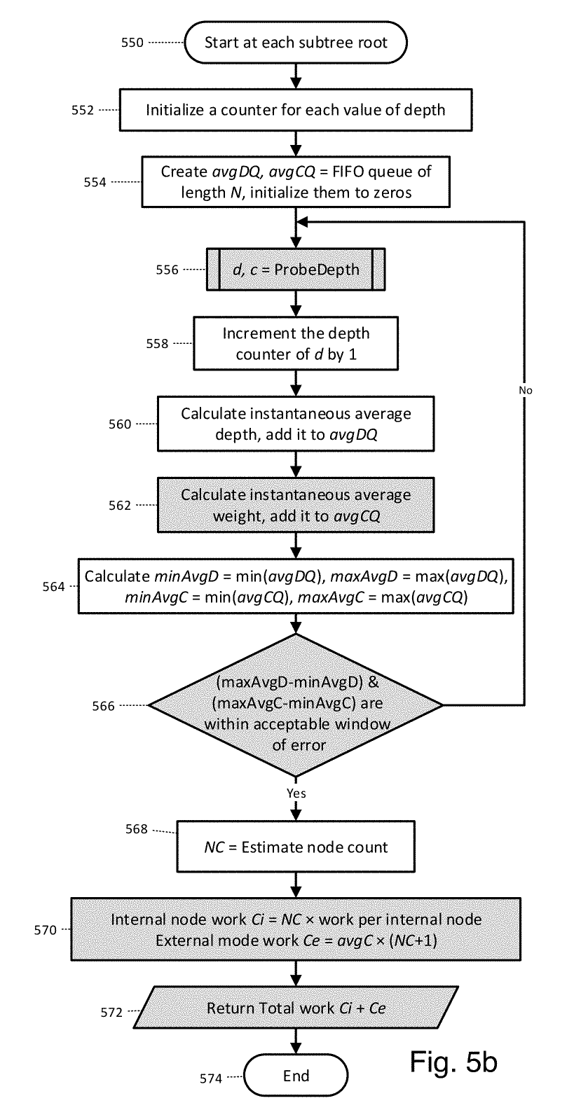

FIG. 5a shows an example of a binary full tree for the another embodiment

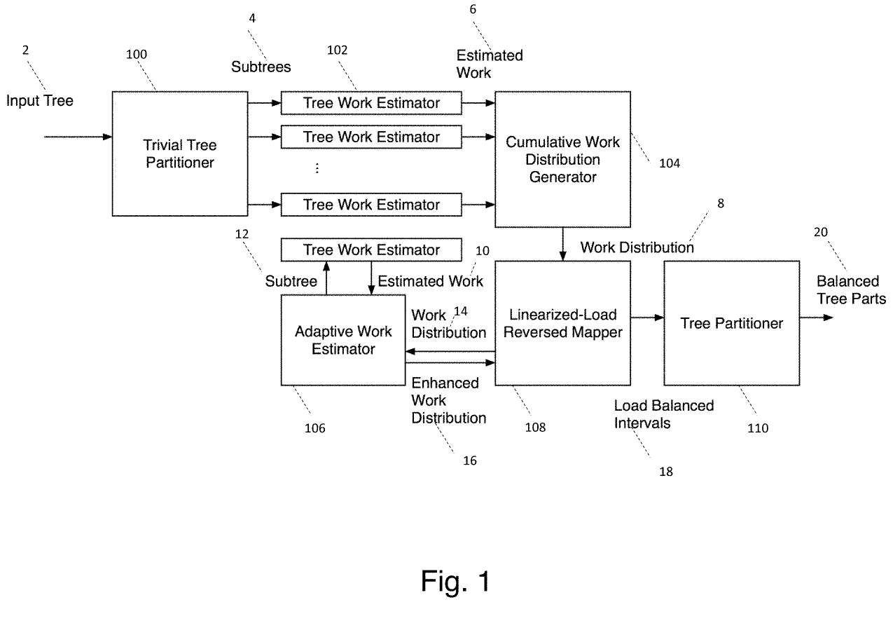

FIG. 5b is a flow chart showing the Work Estimator process shown in FIG. 1 for another embodiment using node counts and leaf work for tree work estimation.

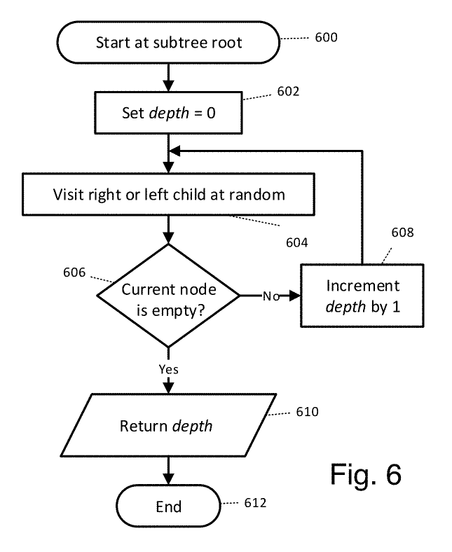

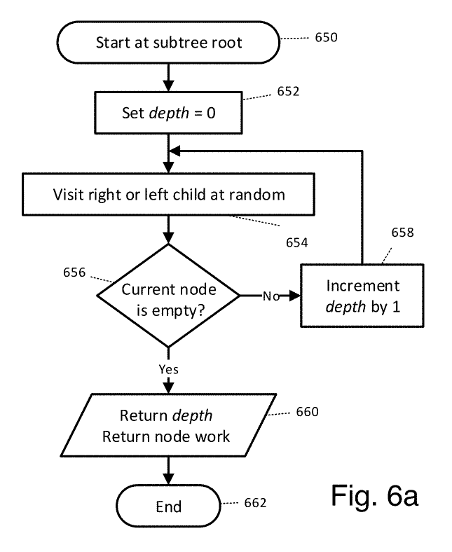

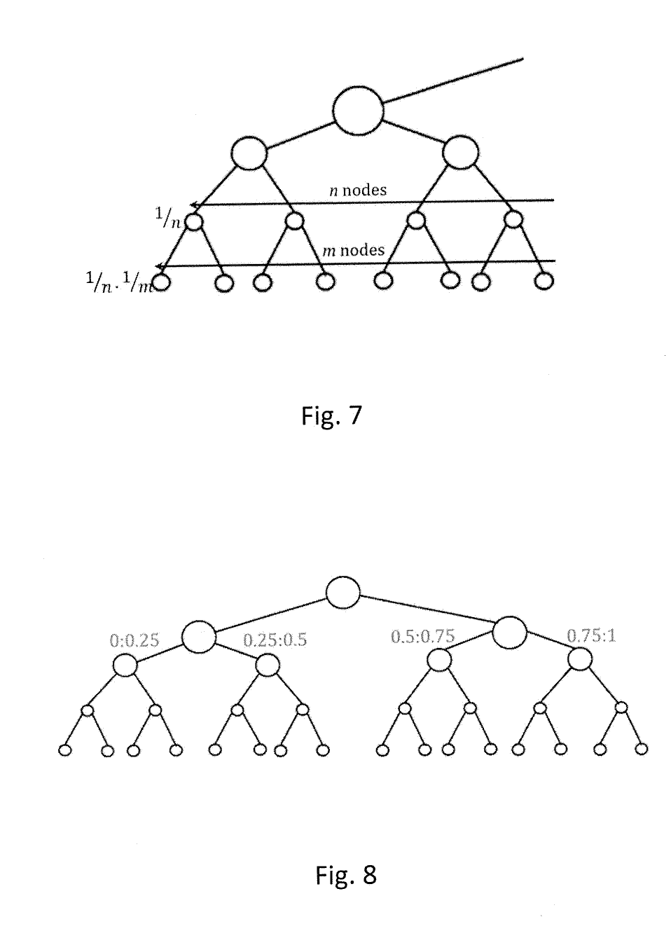

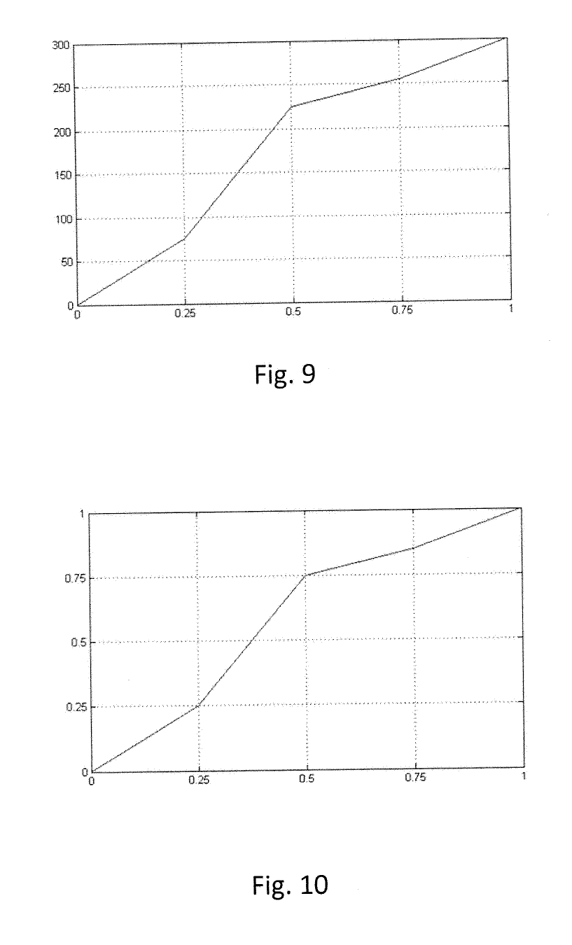

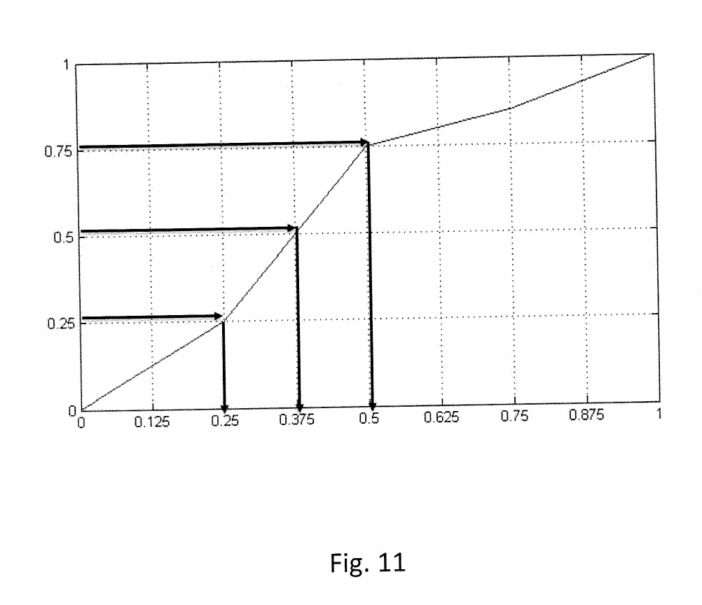

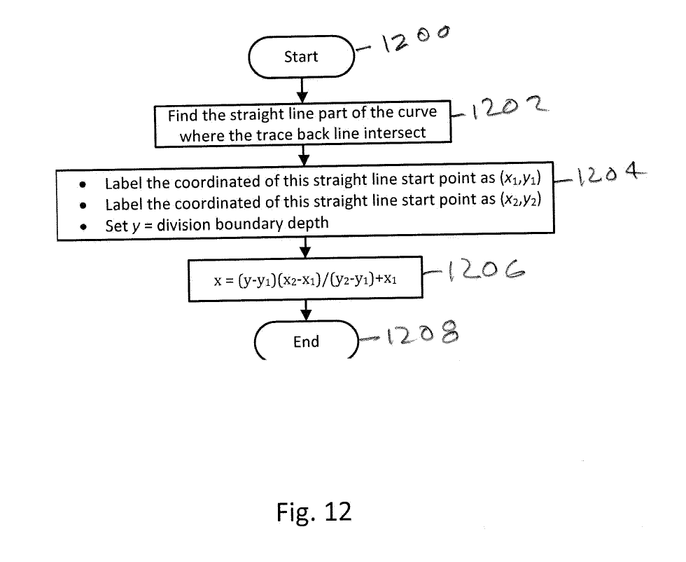

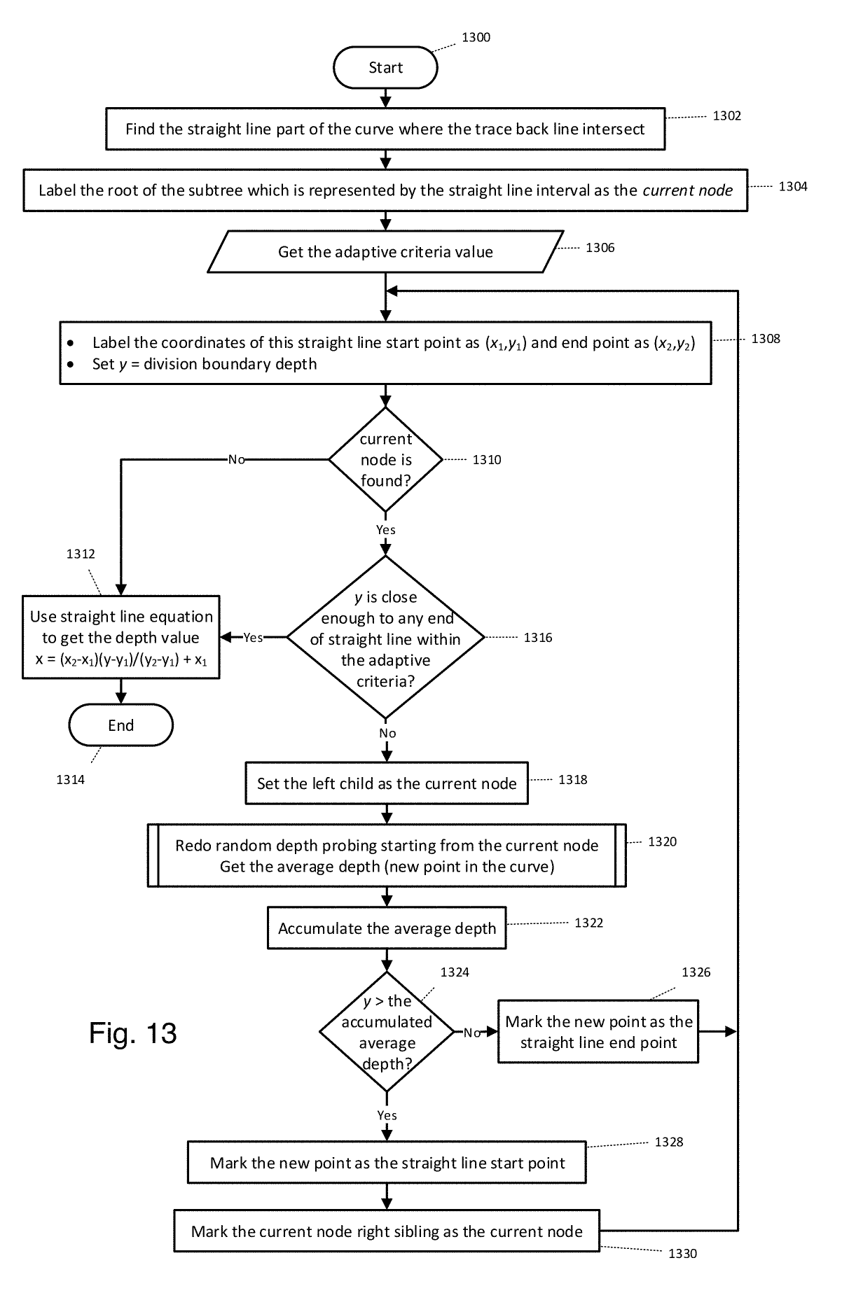

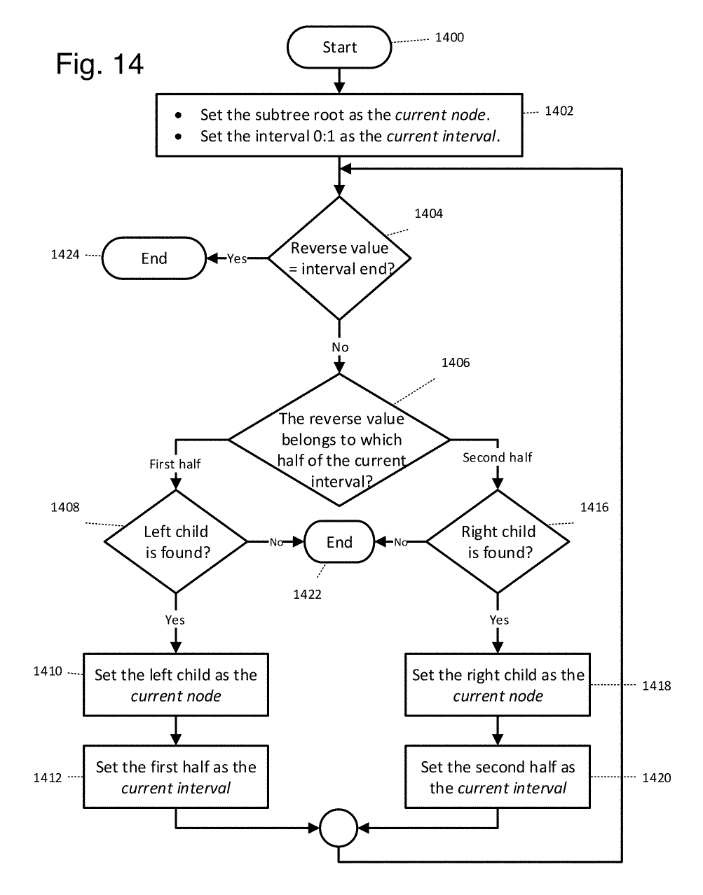

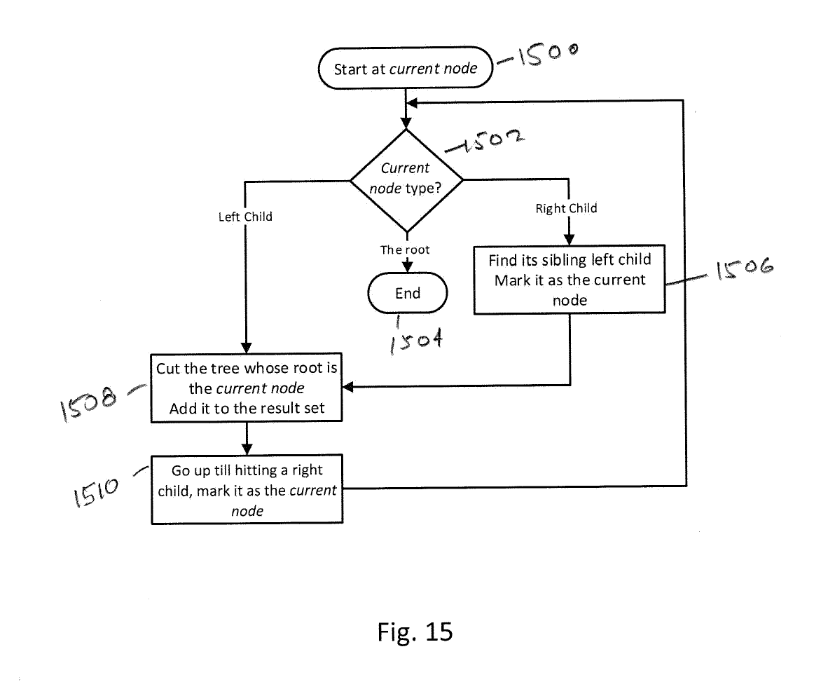

FIG. 6a is a flow chart showing the computation of depth by random probing for another embodiment using node counts and leaf work for tree work estimation.

FIG. 7 is a tree showing the reachability probability for various levels of nodes.

FIG. 8 shows interval labeling for the binary tree example.

FIG. 9 shows an imaginary graph for the accumulated depth values.

FIG. 10 shows dividing the y-axis of the graph of FIG. 9 into p-equivalent divisions.

FIG. 11 shows the trace back operation for the graph of FIG. 10.

FIG. 12 is a flow chart of the trace back operation shown in FIG. 11.

FIG. 13 is a flow chart of the Adaptive Work Estimater process.

FIG. 14 is a flow chart of the process to find the node corresponding to a certain interval label.

FIG. 15 is a flow chart showing the process of cutting all the subtrees within a certain interval.

### DETAILED DESCRIPTION OF THE INVENTION

In reference to FIG. 1, the system overview is shown. The input to the system is a tree 2, which can be a data structure or a routine to generate the tree.

At 100, the Tree Trivial Partitioner partitions the tree by a simple traversal to top nodes, resulting in a fixed number of subtrees 4 equal to the number of available processors in the system. Each subtree 4 is feed, at 100, to a Work Estimator, 102, where each corresponding subtree's work 6 is estimated.

The process relies on uniform sampling of nodes inside each level on the tree as well as the leaves. The obtained estimated works 6 for the subtrees 4 are mapped into corresponding one-dimensional sub-intervals at 104 in the ‘Cumulative Work Distribution Generator’ process, effectively generating a work distribution function. The cumulative work values 8 are then fed, at 104, to the ‘Linearized-Load Reverse Mapping’ process, 106, which generates the corresponding tree work intervals 18. The process also repeatedly computes the distance between the interval bounds and the work distribution points; if the distance is greater than a certain threshold, the process invokes the ‘Adaptive Work Estimator’ process, 106, to compute the mid point between the containing work distribution interval, and estimates the work by invoking the ‘Work Estimator’ process, 102, and feeding it with the corresponding subtree, 12; the latter gives back the work estimate, 10, and the ‘Adaptive Work Estimator’ process, 106, then readjusts the work distribution, generating an enhanced work distribution, 14, and feeds it back to the ‘Linearized-Inverse Mapper’ process, 108.

The final process, at 110, is ‘Tree Partitioner’ which maps the obtained intervals into a set of subtrees 20 where each set represents the load-balanced workload of a processor. For the sake of simplicity a binary tree without loss of generality is considered.

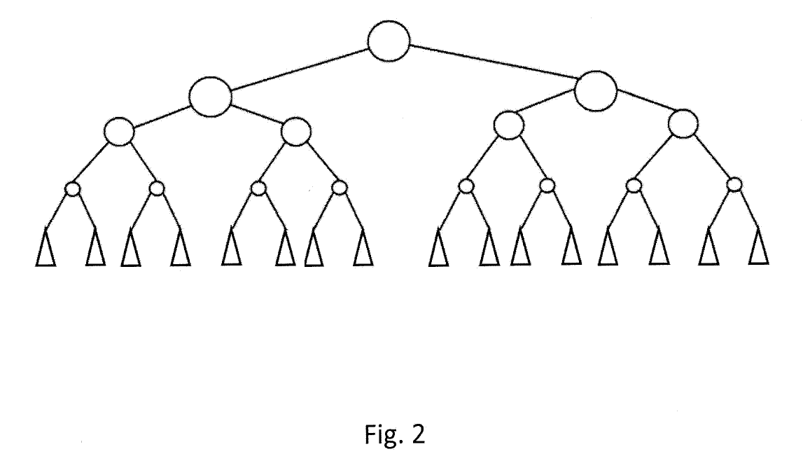

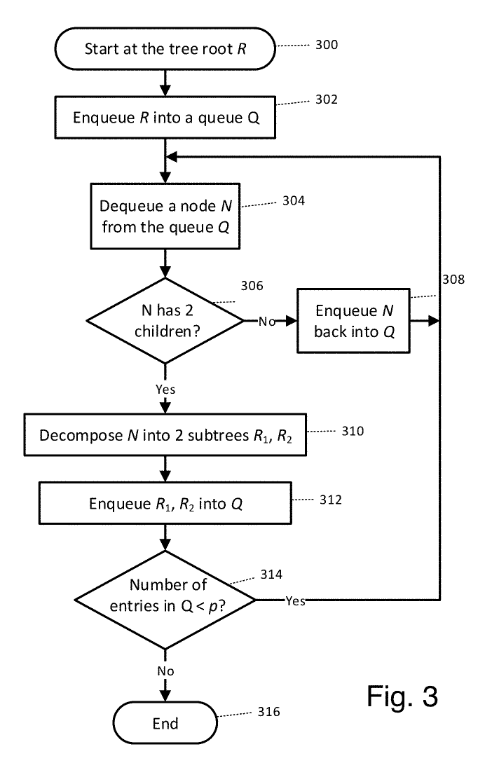

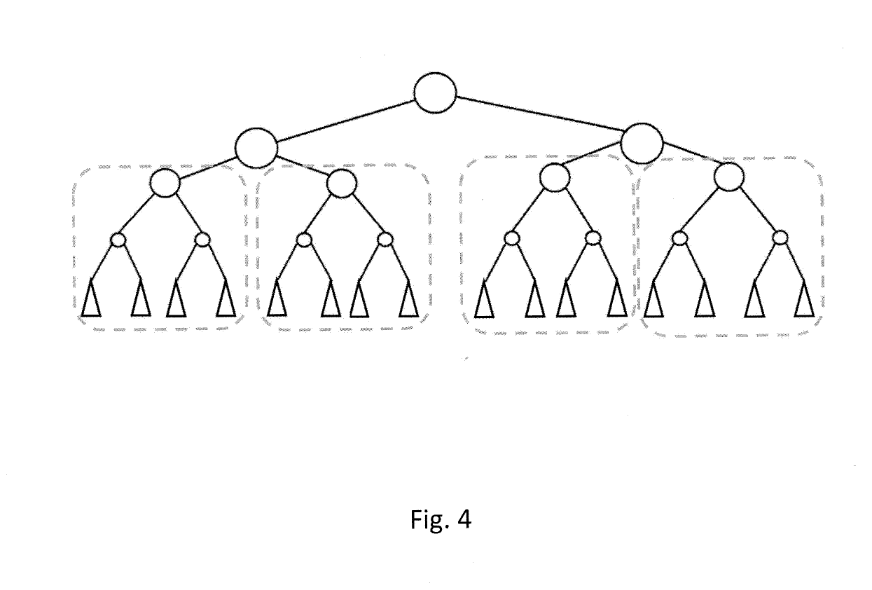

In reference to FIG. 2, a complete binary tree is shown as an example. It is assumed that the number of processors is ‘p’. The process of partitioning the tree consists of finding the first level that contains p or more nodes, each of which becomes the root of a subtree. However, in rare cases where this condition does not exist, for example, for a degenerate tree with only right or left child for each node, a general algorithm for such partition is presented in FIG. 3 as Tree Trivial Partitioning.

In reference to FIG. 3, the algorithm starts at 300. At 302, it enqueues R, the root of the input tree, into a queue (Q), which will eventually contain the roots of all subtrees representing each partition. The algorithm, at 304, dequeues a subtree (root node) from the queue. It then checks, at 306, if the dequeued subtree has two at least two children; if the root node does not have two children, the root node is enqueued back, at 308, then another subtree is dequeued at 304, and the process repeats until a root node is found having two children.

Once a root node is found with two children, it is decomposed into two trees at 310. The decomposition is simply done by returning the immediate left and right children of the given root. The obtained roots (R₁ and R₂) are enqueued back into the queue at 312. The algorithm, at 314, checks to see if the number of trees in the queue is less than the number of available processors, p. If the number of trees in the queue is less than the number of processors, the process, at 304 will dequeue one subtree root N The process thus iterates until the number of subtrees 314 in the queue equals the number of available processors, at which time the process ends at 316.

As shown in reference to FIG. 1 the main operation of this process, ‘Trivial Tree Partitioner,’ is to partition the input tree, 2, into many subtrees equal to the number of processors. The subtrees are then each feed into a ‘Work Estimator’ process, 102, where each obtains the tree estimated work, 6, using random sampling. The ‘Work Estimator’ process will associate a particular subtree, 4, with a corresponding work or a function of it, which represents the required processing time. To calculate the work of a subtree, the subtree is traversed randomly at several random paths (shown as 102 in FIG. 1), calculating the path length of each path, keeping a record of path length distribution and computing the running average height as a stopping criteria. Each iteration of this traversal over a single random path is called a probe.

FIG. 5 shows the flow chart of the ‘Work Estimator’ process. The process estimates the total work for a given subtree. This is done through a random probing routine, accumulation of the depths computed by the probing routine, and finally an efficient way to compute the average tree depth (no need to store prior probe's depth) which is used to terminate the probing and hence the process. The process starts at 500, and, at 502, initializes two variables: W and avg that keeps track of cumulative weights and current average, respectively. Next, at 504 a queue is created that will hold the last N averages.

At 506 the Random Probing routine is invoked. It computes the depth for a random traversal from the given tree root until reaching a null node (a leaf). FIG. 6 shows the flow chart of the algorithm starting at 600. At 602, the initial depth is set at 0. At 604, the process visits one of the children of the tree at random and determines if it is an empty node, at 606. If the child is not a empty (leaf), the depth is incremented at 608. The process iterates until a leaf child is reached, at which time the depth is returned at 610 and the process ends at 612.

Upon finishing the Random Depth Probing routine at 508, next, at 510, a depth counter at the returned depth is incremented by one to maintain the depth histogram. Next at 512, the average depth is calculated using the formula shown and at 514, the cumulative total is updated. At 516, the average calculated at 512 is added to the queue and, at 518, a maximum and minimum average is calculated. At 520, if the difference between the maximum and minimum are within an acceptable range, the process estimates the node count as described below at [0047]. Otherwise, the process is iterated for the next random probe starting at 508.

Note that this algorithm uses a simple queue to decide on a suitable criteria for stopping. In this case, a simple difference operation between ‘the maximum and minimum values is adopted, however, may other measures of variance can be used (such as relative error, standard deviation, etc.).

Upon reaching a stability on the average tree depth, the process estimates the number of nodes in the given subtree: at 522, the computed histograms are accumulated such that the count at depth d is added to all counts with smaller depths. For example, if count) is the count at depth d, and the maximum depth is D then: count₀=count₀+count₁+ . . . +count_{D}, and count₁=count₁+count₂+ . . . +count_{D}, and so on. This computation step results in setting each count to be the sum of all probes that visited such depth.

At 524 the total node count of the given subtree is computed. This is done by first computing the node count at each depth then computating the overall total. Computing the node count at a particular depth d is done by dividing the count of visits at that d to the total number of probes (which gives the ratio of all probes that visit that depth level) and multiply that to the maximum number of nodes that can happen at that depth, which is 2^{d}. This follows from the fact that since we are performing random sampling, the probability of visiting a node at a certain depth is having an equal probability, and empty nodes are not visited; therefore if for example there are ten probes and only 5 of them visited a particular depth, then the level at that depth is half full. The complete formula is thus:

$$Node Count = {\sum }_{d = 0}^{D} \frac{{count}_{d}}{{count}_{0}} \times {2}^{d}$$

Where count₀ is the total number of probes are all probes will visit the root node (at depth 0).

At 526, the process generates the node cout and terminates at 528.

### Another Embodiment for the Work Estimator Process

If the given tree is a full binary subtree where the leaves are associated with variable work, while internal nodes have constant work, this embodiment estimates the total work of the subtree. FIG. 5a presents an example of a full binary tree. It is a tree where each node has either no child or two children. All internal nodes have a work C0 and the leaf nodes have variable work cost of C1, C2, . . . .

FIG. 5b shows a flow chart of the ‘Work Estimator’ process. The process is identical for that in FIG. 5 where computation step 500 maps into 550; 502,504 maps into 554; 506 maps into 556; 510 maps into 558; 512, 514, 516 map 560; 518 maps into 564; 522, 524 maps into 586; and finally 526 maps into 572. The depth probe, 562, is changed so that in addition to computing the depth, it returns the current work associated with the leaf.

FIG. 6a shows a flow chart for the modified Depth Probing routine. It is the same as the one given in FIG. 6 except that it now returns the associated cost with the leaf, at 660. The computation steps 600, 602, 604, 606, 608, 612 map into 650, 652, 654, 656, 658, 662, respectively.

At 562, the algorithm computes the average work per node in using similar formula for computing the average depth, which is: avgW=(avgW×W+c×2^{d})/(W+c×2^{d}), and updating W=W+c×2^{d} where c is the cost of the current leaf node. Also, at 562, the algorithm adds the computed avgW into the queue avgCQ.

At 566, the algorithms decides to stop by comparing the variation of both the average depth values and the average work per leaf values

At 570 the algorithm computes the work for internal nodes by multiplying the obtained node count by the constant work per node, C0. It also computes the work of the leaves by multiplying the average work per leaf by the total number of leaves, NC+1 (due to having a full binary tree). Finally, at 572 the algorithm returns the total work as summation of both internal and external work.

### Reachability Probability

In reference to FIG. 7, a key operation is computing the weighted average. This operation allows for uniform sampling for the leaf nodes. To illustrate, consider the case of simple averaging. The issue here is that leaves that occur at shallow depth have a much higher chance to be sampled than deeper ones. Generally speaking for two leaves separated by delta height=h, the upper one would have 2^{h} more chance of being visited than the lower one.

To normalize this effect, and to provide each leaf with a roughly equal reachability probability, the leaves are normalized by assigning a weight to each leaf. The weight for probe i is defined as follows:

wᵢ=w(dᵢ)=2^{d}^{ᵢ}

### Where:

dᵢ: The depth calculated at probe i
i: The probe index
w( ): is the weight at a given depth

Thus the weighted average that normalizes the bias effect is computed by:

$${avg}_{i} = \frac{{\sum }_{k = 1}^{i} {d}_{k} {w}_{k}}{{\sum }_{k = 1}^{i} {w}_{k}}$$

### Where:

avgᵢ: is the average depth at for probe i.

The equation can be reformulated as a running average as follows:

$$∴ {avg}_{i + 1} = \frac{{\sum }_{k = 1}^{i + 1} {d}_{k} {w}_{k}}{{\sum }_{k = 1}^{i + 1} {w}_{k}} = \frac{{\sum }_{k = 1}^{i} {d}_{k} {w}_{k} + {d}_{i + 1} {w}_{i + 1}}{{\sum }_{k = 1}^{i + 1} {w}_{k}} = \frac{{avg}_{i} {\sum }_{k = 1}^{i} {w}_{k} + {d}_{i + 1} {w}_{i + 1}}{{\sum }_{k = 1}^{i + 1} {w}_{k}} \\ ∴ {avg}_{i} = \frac{{avg}_{i - 1} {\sum }_{k = 1}^{i - 1} {w}_{k} + {d}_{i} {w}_{i}}{{\sum }_{k = 1}^{i} {w}_{k}}$$

### Define

$${W}_{i} = {\sum }_{k = 1}^{i} {w}_{k} ∴ {avg}_{i} = \frac{{avg}_{i - 1} {W}_{i - 1} + {d}_{i} {w}_{i}}{{W}_{i}}$$

Finally,

$${avg}_{i} = \frac{{avg}_{i - 1} {\sum }_{k = 1}^{i - 1} {2}^{{d}_{k}} + {d}_{i} \times {2}^{{d}_{i}}}{{\sum }_{k = 1}^{i} {2}^{{d}_{k}}}$$

This is repeated for each resultant subtree from the trivial partitioning.

Interval Division Algorithm (Accumulative Method)

This process generates a work distribution function by making a linear mapping between the subtrees and a sub interval. In other words, any subtree with an interval is labeled.

The process is as follows:
1. For the root of the input tree, the tree by the interval [0,1] that effectively covers all the nodes within the tree is represented.
2. Each node in a subsequent level covers an equal part of the range regardless of its subtree size. Thus, if there are m nodes in a level, each node i has the sub-interval: [(i−1)/m, i/m].

Accumulative Depth Computing

In reference to FIG. 8, this process accumulates the average depths. The accumulated weighted depth for each subtree is equal to the sum of its depth and its previous subtrees depths.

for i=2 to depths·length do depths[i]←depths[i]+depths[i−1]

### Linearized-Load Reverse Mapping

This process generates the work function by associating the corresponding intervals with the cumulative depths obtained above. For each depth value (depth[i]) the function at the upper bound of the interval to the corresponding x-axis value is defined. The accumulated average depths are plotted, with the end of subtree root interval label on the x-axis (i.e. the interval [0,1]) and the accumulated average weighted depth on the y-axis. It is expected to be a monotonically increasing curve, an example of which is shown in FIG. 9. The x-axis represents the linear space values for the whole tree (i.e. the interval [0,1]), and the y-axis represents the average weighted depth for four subtrees, thereby equally dividing the domain.

In further reference to FIG. 1, due to the accumulation process, the maximum value of the y-axis is the total value of the load which is required to be divided over the available processors. Therefore, if the y-axis range is divided into p equivalent divisions, each division represents an equal part of load.

for j←1 to p do

tracebackValues[j]←j(depths[end]/p)

In reference to FIG. 10, the previous plot after dividing the y-axis into 4 quarters (p=4) is shown.

### Trace Back Operation

In reference to FIG. 11, the traceback operation can be done mathematically by using the straight-line equation to find x-axis value corresponding to the division boundary value, which is the y-axis value:

$$\frac{y - {y}_{1}}{x - {x}_{1}} = \frac{{y}_{2} - {y}_{1}}{{x}_{2} - {x}_{1}} \\ ∴ x = ( y - {y}_{1} ) \frac{{x}_{2} - {x}_{1}}{{y}_{2} - {y}_{1}} + {x}_{1}$$

First, however, the straight-line to use needs to be found (i.e. which x₁, x₂, yᵢ, y₂ to use). The plot contains p−1 lines between each 2 points in the p points that constructs the curve. The straight line needed is where the division boundary traceback intersect with the curve. The flowchart of this operation is shown in FIG. 12. At the end, x will contain the reverse mapped interval value.

At 1200, the process starts and, at 1202, we find the straight line part of the curve where the traceback line intersects. At 1204 boundary points in the curve are identified, and at 1206, the calculation is performed using the equation shown. The process ends at 1208.

### Adaptive Probing (Alternate Embodiment)

For the sake of accuracy in the trace back process, and, because the curve is approximated by only a few points, the division boundary, which is a depth value itself, should be close to an original point of the curve. The closer to that original point the division boundary is, the more accurate the results. How close the points are is an algorithm parameter, which may be called the adaptive criteria:

$$upper adaptive criteria = \frac{{y}_{2} - y}{{y}_{2} - {y}_{1}}$$

$$lower adaptive criteria = \frac{y - {y}_{1}}{{y}_{2} - {y}_{1}}$$

Generally, such a condition cannot be guaranteed, and therefore adaptive probing improves this situation by creating another probe point on the curve, thereby decreasing the approximation error between the fitted points and actual workload.

FIG. 13 shows a flowchart of the algorithm. The process starts at 1300, and, at 1302, the straight line part of the curve where the traceback line intersects is identified. The root of the subtree which is represented by the identified straight line interval becomes, at 1304, the current node for than iteration of the algorithm. At 1306, the boundary points in the curve are identified. At 1310, the algorithm checks to see if the current node has been found, and, if so, at 1316, decides if y is close enough to the end of the straight line, using the adaptive criteria. If so, the depth value is calculated using the equation in 1312, and the process ends at 1314. Otherwise, the left child of the current node is set as the current node at 1318, and the algorithm is recurred using the left child at 1320. At 1322 the average depth is accumulated and, at 1324, it is decided if y is greater than the accumulated depth. If it is, then the new point is identified at the straight line start point at 1328, as well as marking the current node's right sibling as the current node at 1330, otherwise, the point is identified as the straight line end point at 1326. In either case, control returns to 1308 where the boundary points of the new curve are identified. The adaptive probing re-probes at the interval label of the middle of the straight line of intersection (from the reverse mapping process). This generates another depth value at the middle of the interval label, which represents the left child node of the current subtree node. The algorithm iteratively checks the adaptive criteria and re-probes if it is not satisfied.

Tree Final Division Algorithm

The reverse mapped x value of each division is the load reverse value of the corresponding processor in order. For each processor reverse value, find the node whose interval label ends with it. The flowchart for this operation is shown in FIG. 14.

The input to this algorithm is the ‘reverse value’ and the root of the given tree; the algorithm successively visits left or right children depending on the given ‘reverse value’, which means that the algorithm visits the child whose interval contains the sought reverse value. The process continues until reaching a leaf. In general, an interval that ends with the ‘reverse value’, which would require matching many subtrees is sought

The process start at 1400 and, at 1402, the root of the subtree is set as the current node. At 1404 it is decided if the reverse value equals the interval end, and, of so, the process ends at 1424. If not, at 1406, the process determines which half of the current interval contains the reverse value, and, if the current node is contained in the selected half at 1408 and 1416. If so, the process ends at 1422. If not, the left or right child is set as the current node and the current interval is set, as shown respectively at 1410, 1412 and 1418,1420, and the process return to 1404 using the new current node and interval.

FIG. 15 shows the corresponding algorithm for gathering all required subtrees. The algorithm starts at 1500 using the final node (leaf) identified above. At 1502, the node would generally be a left child, which would require clipping the node and defining a new subtree, as the parent would extend the coverage range beyond the sought reverse value. The algorithm traverses up the tree from the current node until reaching the first right child node at 1506, and then takes the left sibling as a new subtree at 1508. The algorithm recursively repeats at 1510 until reaching the root and finally terminates at 1504.

The overall algorithm is applied p−1 times to generate p−1 partitions for p−1 processors. For the last processor, the root will be the remaining partition.

We claim:

1. A system for increasing the processing efficiency of a tree-based application in a parallel processing environment comprising:
two or more parallel processors;
an application executing on said two or more parallel processors, said application utilizing a tree structure; and
software, incorporated into said application, to balance the processing of said tree structure between said two or more processors, said software performing the functions of:
partitioning said tree structure into two or more a number of subtrees;
estimating the work of each of said subtrees;
generating a work distribution function by mapping said work of each of said subtrees into corresponding one-dimensional sub-intervals using an accumulated work for each subtree; and
mapping each of said obtained sub-intervals into a set of subtrees representing the load-balanced workload for one of said processors.

2. The system of claim 1 wherein said partitioning step divides said tree structure into a number of subtrees equal to the number of said parallel processors.

3. The system of claim 1 wherein said step of estimating node count of each subtree utilizes random depth probing wherein each of said subtrees is traversed by randomly selecting one child at each intermediate node of said subtree.

4. The system of claim 3 wherein said step performs the further functions of:
associating each depth with a depth count
incrementing the corresponding depth count after each depth probing traversing the tree and terminating at a leaf
repeating the above steps for a plural number of repetitions
accumulating the depth counts in a reverse obtaining
estimating the number of nodes at each depth level by dividing the corresponding accumulated depth count by total number of probes an multiplying by the levels maximum number of nodes (in successive powers of 2)
estimating the total number of nodes in a subtree by summation of all nodes counts at each level

5. The system of claim 1 wherein said step of estimating work of the leaves each full subtree utilizing random depth probing wherein each of said subtrees is traversed by randomly selecting one child at each intermediate node of said subtree.

6. The system of claim 1 wherein said generating step performs the further functions of:
assigning a weight for each leaf in each subtree, said weight for each leaf being a function of the depth of said leaf within its subtree; and
normalizing each of said leaves based on said weight, such that each leaf has a roughly equal chance of being sampled.

7. The system of claim 6 wherein is cumulated average depth for each subtree is an average weighted depth.

8. The system of claim 7 wherein the total workload is divided into a number of equal portions corresponding to the number of said processors.

9. The system of claim 8 wherein said average weighted depth of each subtree represents its portion of the total workload relative to every other subtree.

10. The system of claim 1 wherein said generating step performs the further functions of:
assigning a weight for each leaf in each subtree, said weight for each leaf being a function of the work of said leaf within its subtree; and
normalizing each of said leaves based on said weight, such that each leaf has a roughly equal chance of being sampled.
